(19) United States
(12) Patent Application Publication
(10) Pub. No.: US 2012/0044550 A1
(43) Pub. Date: Feb. 23, 2012

(54) TRANSMISSION TYPE VOLUME HOLOGRAM RECORDING MEDIUM AND MANUFACTURING METHOD THEREOF

(75) Inventors: Tomoya Mizuta, Hyogo (JP); Hiroto Miyake, Hyogo (JP)

(73) Assignee: Daicel Chemical Industries, Ltd., Osaka (JP)

(21) Appl. No.: 13/266,375

(22) PCT Filed: Mar. 18, 2010
(86) PCT No.: PCT/JP2010/054665

§ 371 Date: Oct. 26, 2011

(30) Foreign Application Priority Data
Apr. 28, 2009 (JP) 2009-110166

(51) Int. Cl. G03H 1/02; G03H 1/04

(52) U.S. Cl. 359/3; 430/2

(57) ABSTRACT

Provided is a transmission-type volume hologram recording medium for use in a two-beam hologram recording system, which has a high diffraction efficiency and is capable of significantly reducing the intensity of higher-order diffracted light, which causes a noise, than first-order diffracted light.

The transmission-type volume hologram recording medium includes two facing substrates of dissimilar materials and, held between them, a volume hologram recording layer of a volume hologram recording photosensitive composition. The substrates holding the volume hologram recording layer therebetween preferably have transparency in the visible light region and have thicknesses each from 2 to 2000 μm. The difference in refractive index between the two substrates holding the volume hologram recording layer therebetween is preferably from 0.001 to 0.5. The difference in thickness between the two substrates holding the volume hologram recording layer therebetween is preferably from 1 to 1500 μm.

### TECHNICAL FIELD

The present invention relates to a transmission-type volume hologram recording medium having a multilayer structure, and to a manufacturing method of the recording medium. More specifically, the present invention relates to a transmission-type volume hologram recording medium and a manufacturing method thereof, which recording medium, when subjected to a hologram recording by a two-beam interference technique, has a satisfactory diffraction efficiency and may significantly reduce the intensity of higher-order diffracted light, which causes a noise, than first-order diffracted light.

### BACKGROUND ART

Volume holograms are widely used typically in design, security, and optical element applications, because they can render images three-dimensionally, have high diffraction efficiencies and wavelength selectivities, and require advanced production techniques. Volume holograms are prepared by allowing object light and reference light, which are highly coherent and are of a single wavelength, to interfere with each other and allowing the coherent light to come into a volume hologram recording material to record, as interference fringes, three-dimensional information regarding the object in the material. The interference fringes are recorded as refractive index modulation corresponding to the bright and dark parts of the coherent light. As having such characteristic properties, hologram memories have recently received attention as large-capacity recording media; and hologram recording materials for use therein require properties such as a high diffraction efficiency, a low cure shrinkage, and a high sensitivity.

Typically, Patent Literature (PTL) 1 discloses a volume hologram recording medium which includes two transparent supports and a recording layer held between the two supports, in which the two supports are the same as or different from each other, and the recording layer is made from a photosensitive composition containing a cationically polymerizable compound being liquid at normal temperature (at room temperature), a radically polymerizable compound, a photo-induced radical polymerization initiator, and a cationic polymerization initiator. The technique disclosed in this literature is a reflection hologram recording technique which exhibits satisfactory characteristic properties for arts and security uses. It is pointed out, however, that the technique has problems such as not having sufficient applicability to large-capacity recording and requiring, for example, mechanical correction upon reproduction after recording.

Hologram recording techniques are roughly classified as reflection recording and transmission recording. The technique disclosed in the literature (i.e., reflection recording) is a recording technique in which recording light and reference light are allowed to come into a recording medium from directions (planes) opposite to each other, and recording is performed using the resulting diffracted light. In contrast, the transmission recording is a recording technique in which recording light and reference light are allowed to come into a recording medium from the same direction (plane), and recording is performed using the resulting interfering light. Diffraction gratings formed by the interfering light are formed in parallel with the plane (principal plane of the medium) in reflection recording but are formed in a direction perpendicular to the plane in transmission recording. Accordingly, transmission recording, which can effectively utilize recording in the thickness direction, is preferred for high-capacity recording. Laser light, when coming into the recording medium, is gradually absorbed and is decreased in its intensity toward the depth direction. Reflection recording, in which diffraction gratings are formed by the interference of decreased laser light, requires higher exposure energy than that in transmission recording. In addition, the reflection recording technique suffers from the presence of a portion merely responded or reacted to the laser light, thereby fails to use monomers effectively, and remains problematic in use for high-capacity recording of several terabytes or higher. In particular, when employing dissimilar substrates, reflection recording suffers from subtle misregistration between a recording site and a reproducing position due to differences in thickness and refractive index between the substrates.

### CITATION LIST

### Patent Literature

PTL 1: Japanese Unexamined Patent Application Publication (JP-A) No. 2007-34334

### SUMMARY OF INVENTION

### Technical Problem

An object of the present invention is to provide a transmission-type volume hologram recording medium for use in a two-beam hologram recording system, which medium has a high diffraction efficiency and is capable of significantly reducing the intensity of higher-order diffracted light, which causes a noise, than first-order diffracted light. Another object of the present invention is to provide a method for simply and easily manufacturing the transmission-type volume hologram recording medium.

### Solution to Problem

After intensive investigations to achieve the objects, the present inventors have found that a volume hologram recording medium including two dissimilar transparent substrates and, held between them, a volume hologram recording layer, when used in a two-beam interference transmission-type hologram recording system, exhibits a high diffraction efficiency and is capable of significantly reducing the intensity of higher-order diffracted light, which causes a noise, than first-order diffracted light, as compared to a customary recording medium including two transparent substrates of the same material and, held between them, a volume hologram recording layer. The present invention has been made based on these findings.

Specifically, the present invention provides, in an aspect, a transmission-type volume hologram recording medium which includes two facing substrates composed of dissimilar materials to each other; and a volume hologram recording layer held between the two substrates and composed of a volume hologram recording photosensitive composition.

In a preferred embodiment of the transmission-type volume hologram recording medium, the two substrates holding the volume hologram recording layer therebetween are each transparent to light in the visible light region and have a thicknesses each in the range of from 2 to 2000 μm. In another preferred embodiment, the recording medium has a difference in refractive index of from 0.001 to 0.5 between the two substrates holding the volume hologram recording layer therebetween. In still another preferred embodiment, the recording medium has a difference in thickness of from 1 to 1500 μm between the two substrates holding the volume hologram recording layer therebetween.

In yet another preferred embodiment, upon reproduction of a hologram recorded on the recording medium, the intensity of second-order diffracted light is 10% or less with respect to the intensity of first-order diffracted light.

The present invention further provides, in another aspect, a method for manufacturing a transmission-type volume hologram recording medium, the method includes the step of forming a volume hologram recording layer between first and second substrates, the volume hologram recording layer including a volume hologram recording photosensitive composition, and the first and second substrates made from dissimilar materials to each other.

The method for manufacturing a transmission-type volume hologram recording medium may include the method includes the steps of applying the volume hologram recording photosensitive composition to the first substrate to form a coat layer thereon; and covering the coat layer with the second substrate made from a dissimilar material to that of the first substrate. The method in this embodiment may include the steps of drying and removing a solvent from the coat layer formed on the first substrate; and covering the dried coat layer with the second substrate made from a dissimilar material to that of the first substrate.

### Advantageous Effects of Invention

The transmission-type volume hologram recording medium according to the present invention has a high diffraction efficiency, is capable of significantly reducing the intensity of higher-order diffracted light, and excels in separability between first-order diffracted light and second-order diffracted light, as compared to a customary transmission-type volume hologram recording medium including transparent substrates of the same material and, held therebetween, a volume hologram recording layer.

The manufacturing method according to the present invention enables simple and easy manufacturing of the transmission-type volume hologram recording medium having such satisfactory properties.

### BRIEF DESCRIPTION OF DRAWINGS

FIG. 1 is a schematic diagram illustrating an optical system used in examples and comparative examples below for the determination of diffraction efficiency and ratio of second-order diffracted light to first-order diffracted light.

### DESCRIPTION OF EMBODIMENTS

A transmission-type volume hologram recording medium according to an embodiment of the present invention has a structure including two substrates made from dissimilar materials and facing each other; and a volume hologram recording layer including a volume hologram recording photosensitive composition and held between the two substrates.

### [Volume Hologram Recording Photosensitive Composition]

Volume hologram recording photosensitive compositions are roughly classified by the curing mechanism as three types, i.e., cationically curable compositions, radically curable compositions, and “hybrid” compositions employing both a cationically curable component and a radically curable component in combination. Cationically curable photosensitive compositions each generally include one or more photo-induced cationically polymerizable compounds (photo-induced cationically curable compounds) each having at least one cationically curable group selected typically from epoxy group, vinyl ether group, and oxetane group; a binder polymer; a photo-induced cationic polymerization initiator; and a sensitizer (sensitizing dye). Radically curable photosensitive compositions each generally include one or more photo-induced radically polymerizable compounds (photo-induced radically curable compounds) each having a radically polymerizable group, such as an acrylate, a methacrylate, or a vinyl compound; and a photo-induced radical polymerization initiator and may further include a sensitizer (sensitizing dye). Hybrid photosensitive compositions each include a photo-induced radically curable compound and a photo-induced cationically curable compound. Such volume hologram recording photosensitive compositions may further contain other components such as plasticizers and other additives, and solvents according to necessity.

[Photo-Induced Cationically Polymerizable Compound]

The photo-induced cationically polymerizable compound is not limited, as long as being a compound having a photo-induced cationically polymerizable group, but is preferably a compound having, in the molecule, at least one cationically polymerizable group selected from the group consisting of epoxy group, vinyl ether group, and oxetanyl group. Each of different photo-induced cationically polymerizable compounds (A) may be used alone or in combination.

Exemplary epoxy-containing compounds (epoxy compounds) include alicyclic epoxy resins each intramolecularly having a cyclic aliphatic group and an epoxy group; and epoxy resins each intramolecularly having a glycidyl group. Among them, alicyclic epoxy resins are preferred, of which more preferred are compounds whose epoxy group (oxirane ring) is formed as including two adjacent carbon atoms constituting the cyclic aliphatic group. The epoxy-containing compounds for use herein may be whichever of monofunctional epoxy compounds and multifunctional epoxy compounds, of which multifunctional epoxy compounds are preferred. Each of different epoxy-containing compounds may be used alone or in combination.

Exemplary alicyclic epoxy resins include 3,4,3′,4′-diepoxybicyclohexyl, bis(3,4-epoxycyclohexyl) adipate, 3,4-epoxycyclohexylmethyl 3′,4′-epoxycyclohexane carboxylate, (3,4-epoxy-6-methylcyclohexyl)methyl 3′,4′-epoxy-6-methylcyclohexane carboxylate, ethylene 1,2-bis(3,4-epoxycyclohexanecarboxylic acid) ester, 3,4-epoxycyclohexylmethyl alcohol, and 3,4-epoxycyclohexylethyltrimethoxysilane. Exemplary commercially available products usable herein as alicyclic epoxy resins include CELLOXIDE 2000, CELLOXIDE 2021, CELLOXIDE 3000, and EHPE 3150 each supplied by Daicel Chemical Industries, Ltd.; EPOMIK VG-3101 supplied by Mitsui Chemicals Inc.; E-1031S supplied by JER (Japan Epoxy Resins Co., Ltd.); TETRAD-X and TETRAD-C each supplied by Mitsubishi Gas Chemical Company, Inc.; and EPB-13 and EPB-27 each supplied by Nippon Soda Co., Ltd.

The vinyl-ether-containing compounds (vinyl ether compounds) are not limited, as long as being compounds each containing at least one vinyl ether group and may be whichever of monofunctional vinyl ether compounds and multifunctional vinyl ether compounds. Among them, multifunctional vinyl ether compounds are preferred. Each of different vinyl-ether-containing compounds may be used alone or in combination.

Typical examples of vinyl-ether-containing compounds include cyclic-ether-type vinyl ethers (vinyl ethers each containing a cyclic ether group such as oxirane ring, oxetane ring, or oxolane ring) such as isosorbide divinyl ether and oxynorbornene divinyl ether; aryl vinyl ethers such as phenyl vinyl ether; alkyl vinyl ethers such as n-butyl vinyl ether and octyl vinyl ether; cycloalkyl vinyl ethers such as cyclohexyl vinyl ether; and multifunctional vinyl ethers such as hydroquinone divinyl ether, 1,4-butanediol divinyl ether, cyclohexane divinyl ether, and cyclohexane dimethanol divinyl ether. Exemplary vinyl-ether-containing compounds usable herein also include 2-hydroxyethyl vinyl ether (HEVE), diethylene glycol monovinyl ether (DEGV), 2-hydroxybutyl vinyl ether (HBVE), and triethylene glycol divinyl ether each available from Maruzen Petrochemical Co., Ltd., and further include vinyl ether compounds each having one or more substituents such as alkyl groups and allyl groups at the alpha position and/or beta-position.

The oxetanyl-containing compounds (oxetane compounds) are not limited, as long as being compounds having at least one oxetanyl group, and may be whichever of monofunctional oxetane compounds and multifunctional oxetane compounds, of which multifunctional oxetane compounds are preferred. Each of different oxetanyl-containing compounds may be used alone or in combination.

Typical examples of oxetanyl-containing compounds include 3,3-dimethanol divinyl ether oxetane having an oxetanyl group and vinyl ether groups; and 3-ethyl-3-(phenoxymethyl)oxetane (PDX), di[1-ethyl(3-oxetanyl)]methyl ether (DOX), 3-ethyl-3-(2-ethylhexyloxymethyl)oxetane (EHOX), 3-ethyl-3-{[3-(triethoxysilyl)propoxy]methyl}oxetane (TESOX), oxetanylsilsesquioxane (OX-SQ), and phenol novolak oxetane (PNOX-1009) each available from Toagosei Co., Ltd.

The photo-induced cationically polymerizable compound is preferably a combination of at least one epoxy compound with at least one compound selected from the group consisting of vinyl ether compounds and oxetane compounds, for high polymerization reactivity. In this combination use, the ratio of the at least one epoxy compound to the at least one compound selected from the group consisting of vinyl ether compounds and oxetane compounds is, on the mole basis, typically from 5:95 to 98:2, preferably from 20:80 to 95:5, more preferably from 50:50 to 95:5, and particularly preferably from 70:30 to 95:5.

The photo-induced cationically polymerizable compound for use herein may be one which has been subjected to a heating treatment at a temperature equal to or lower than its boiling point. The heating may be performed typically at a temperature of 80° C. or higher but the boiling point or lower (e.g., from 80° C. to 150° C.) and preferably at a temperature of 85° C. or higher but the boiling point or lower (e.g., from 85° C. to 130° C.). Though not critical, the heating time is generally from about 0.1 to about 24 hours, preferably from about 0.2 to about 10 hours, and more preferably from about 0.5 to about 5 hours. The heating treatment may be performed in an air atmosphere or in an atmosphere of an inert gas such as nitrogen. Of such atmospheres, air atmosphere is preferred. The heating treatment may be performed under normal atmospheric pressure, under reduced pressure, or under a pressure (under a load). The use of a photo-induced cationically polymerizable compound which has been subjected to a heating treatment at a temperature equal to or lower than its boiling point helps the recording medium to be significantly improved in hologram properties such as diffraction efficiency, probably because the use increases the miscibility between monomers.

[Binder Polymer]

Examples of the binder polymer (binder resin) include poly (meth)acrylic esters or partially hydrolyzed products thereof, poly(vinyl acetate)s or hydrolyzed products thereof, poly(vinyl alcohol)s or partially acetalized products thereof, triacetylcellulose, polyisoprenes, polybutadienes, polychloroprenes, poly(vinyl chloride)s, polyarylates, chlorinated polyethylenes, chlorinated polypropylenes, poly(N-vinylcarbazole)s or derivatives thereof, poly(N-pyrrolidone)s or derivatives thereof; polymers or copolymers of styrene or another monomer having a benzene ring, or of vinylnaphthalene or another monomer having a naphthalene ring (e.g., polystyrenes, poly-1-vinylnaphthalenes, poly-2-vinylnaphthalenes, copolymers between vinylnaphthalene and an acrylate, copolymers between styrene and maleic anhydride, or half-esters of them); copolymers containing, as a polymerizable component, at least one selected from copolymerizable monomers such as acrylic acid, an acrylic ester, methacrylic acid, a methacrylic ester, acrylamide, acrylonitrile, ethylene, propylene, vinyl chloride, and vinyl acetate; and mixtures of these. Among them, polymers or copolymers of a monomer having a naphthalene ring are preferred.

The binder polymer has a weight-average molecular weight of typically from about 1×10⁴ to about 100×10⁴, and preferably from about 4×10⁴ to about 30×10⁴.

The binder polymer preferably has a refractive index larger than that of the photo-induced cationically polymerizable compound. The binder polymer is preferably one having a refractive index different from that of the photo-induced cationically polymerizable compound typically preferably by about 0.001 to about 0.5 and particularly preferably by about 0.1 to about 0.3. The binder polymer, when having such characteristic properties, helps the recording medium to exhibit further satisfactory hologram properties.

The binder polymer may be used in the volume hologram recording photosensitive composition in an amount of typically from 10 to 200 parts by weight and preferably from 30 to 100 parts by weight, per 100 parts by weight of the photo-induced cationically polymerizable compound or compounds (total amount).

[Photo-Induced Cationic Polymerization Initiator]

The photo-induced cationic polymerization initiator is not limited, as long as being a compound that activates photo-induced cationic polymerization, and examples thereof include aromatic diazonium salts, aromatic iodonium salts, aromatic sulfonium salts, aromatic phosphonium salts, and mixed ligand metal salts such as (η6-benzene) (η5-cyclopentadienyl)iron (II) and silanol-aluminum complexes. Each of different photo-induced cationic polymerization initiators may be used alone or in combination.

The photo-induced cationic polymerization initiator is used in an amount of typically from 0.1 to 30 parts by weight and preferably from 1 to 20 parts by weight, per 100 parts by weight of the photo-induced cationically polymerizable compound or compounds (total amount). The photo-induced cationic polymerization initiator is preferably one that will be decomposed, after hologram recording, into a substance having no reactivity, from the viewpoint of stability of the recorded hologram.

[Sensitizing Dye]

The sensitizing dye is not limited, as long as being one that sensitizes the photopolymerization initiator (photo-induced polymerization initiator) and may be any of known sensitizing dyes. Exemplary sensitizing dyes include thiopyrylium salt dyes, melocyanine dyes, quinoline dyes, styrylquinoline dyes, ketocoumarin dyes, thioxanthene dyes, xanthene dyes, oxonol dyes, cyanine dyes, rhodamine dyes, and pyrylium salt dyes. The sensitizing dye, when being a visible light sensitizing dye and used in optical elements and other applications requiring high transparency, is preferably one that will be decomposed into a colorless transparent substance by the action of a process downstream from hologram recording, such as heating or ultraviolet ray irradiation. Each of different sensitizing dyes may be used alone or in combination.

The sensitizing dye is used in an amount of typically from 0.01 to 20 parts by weight and preferably from 0.01 to 10 parts by weight, per 100 parts by weight of the photo-induced cationically polymerizable compound or compounds (total amount).

[Photo-Induced Radically Polymerizable Compound]

The photo-induced radically polymerizable compound is not limited, as long as being a compound having at least one photo-induced radically polymerizable group, and examples thereof include compounds each having at least one (preferably two or more) ethylenically unsaturated double bonds capable of undergoing addition polymerization. Preferred examples of such compounds include unsaturated carboxylic acids; salts of unsaturated carboxylic acids; ester compounds between an unsaturated carboxylic acid and an aliphatic polyhydric alcohol; and amide compounds between an unsaturated carboxylic acid and an aliphatic multivalent amine compound. Each of different photo-induced radically polymerizable compounds may be used alone or in combination and may be used in combination with one or more photo-induced cationically polymerizable compounds.

Typical examples of photo-induced radically polymerizable compounds include monofunctional or multifunctional acrylic esters; and monofunctional or multifunctional methacrylic esters.

Exemplary monofunctional acrylic esters include ethylene glycol monoacrylate, triethylene glycol monoacrylate, 1,3-butanediol monoacrylate, tetramethylene glycol monoacrylate, propylene glycol monoacrylate, and neopentyl glycol monoacrylate. Exemplary multifunctional acrylic esters include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolethane triacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, and dipentaerythritol hexaacrylate.

Exemplary monofunctional methacrylic esters include ethylene glycol monomethacrylate, triethylene glycol monomethacrylate, 1,3-butanediol monomethacrylate, tetramethylene glycol monomethacrylate, propylene glycol monomethacrylate, and neopentyl glycol monomethacrylate. Exemplary multifunctional methacrylic esters include ethylene glycol dimethacrylate, triethylene glycol dimethacrylate, 1,3-butanediol dimethacrylate, tetramethylene glycol methacrylate, propylene glycol dimethacrylate, neopentyl glycol dimethacrylate, trimethylolpropane trimethacrylate, trimethylolethane trimethacrylate, tetraethylene glycol dimethacrylate, pentaerythritol dimethacrylate, pentaerythritol trimethacrylate, pentaerythritol tetramethacrylate, dipentaerythritol dimethacrylate, dipentaerythritol trimethacrylate, dipentaerythritol tetramethacrylate, and dipentaerythritol hexamethacrylate.

[Photo-Induced Radical Polymerization Initiator]

The photo-induced radical polymerization initiator is not limited, as long as being a compound that activates photo-induced radical polymerization. Examples thereof include peroxy esters such as t-butyl peroxybenzoate; peroxides such as t-butyl hydroperoxide and di-t-butyl peroxide; benzoin and benzoin alkyl ethers, such as benzoin, benzoin methyl ether, benzoin ethyl ether, and benzoin isopropyl ether; acetophenones such as acetophenone, 2,2-dimethoxy-2-phenylacetophenone, 2,2-diethoxy-2-phenylacetophenone, 1,1-dichloroacetophenone, 2-methyl-1-[4-(methylthio)phenyl]-2-morpholino-propan-1-one, and 2-benzyl-2-dimethylamino-1-(4-morpholinophenyl)-butan-1-one; anthraquinones such as 2-methylanthraquinone, 2-ethylanthraquinone, 2-(tert-butyl)anthraquinone, 1-chloroanthraquinone, and 2-amylanthraquinone; thioxanthones such as 2,4-dimethylthioxanthone, 2,4-diethylthioxanthone, 2-chlorothioxanthone, and 2,4-isopropylthioxanthone; ketals such as acetophenone dimethyl ketal and benzyl dimethyl ketal; benzophenones such as benzophenone; xanthones; 1,7-bis(9-acridinyl)heptane; the aromatic iodonium salts and aromatic sulfonium salts listed above as the photo-induced cationic polymerization initiator; and other known photoinitiators. Each of different photo-induced radical polymerization initiators may be used alone or in combination.

Such photo-induced radical polymerization initiators may be used in an amount of typically from 0.1 to 30 parts by weight and preferably from 1 to 20 parts by weight, per 100 parts by weight of the photo-induced radically polymerizable compound or compounds (total amount).

[Volume Hologram Recording Layer]

The volume hologram recording layer herein is composed of the volume hologram recording photosensitive composition.

The volume hologram recording layer has a thickness of typically from 1 to 2000 μm and preferably from 10 to 1000 μm. The volume hologram recording layer, if having an excessively small thickness, may generally give a hologram with a low angular selectivity and, in contrast, if having a large thickness, may give a hologram with a high angular selectivity.

[Substrates]

According to the present invention, the volume hologram recording layer is held between two substrates (also referred to as “base plates”) which are made from dissimilar materials to each other and which face each other. It is important that the facing substrates are made from dissimilar materials to each other. In a reflection-type hologram recording system, a recording medium, if including two substrates made from dissimilar materials and a volume hologram recording layer held between the two substrates, may fail to provide a hologram recording with high precision, because the reproducing position subtly deviates from the recording site due to differences in thickness and refractive index between the two dissimilar substrates. In contrast, when a volume hologram recording medium including two substrates made from dissimilar materials and, held therebetween, a volume hologram recording layer is used for a transmission-type hologram recording system, in which recording light and reference light are allowed to come into the medium from the same direction (same plane), the recording medium surprisingly provides a hologram recording with high diffraction efficiency and high sensitivity as compared to a recording medium including two substrates made from the same material and, held therebetween, a volume hologram recording layer.

The substrates for use herein are not limited, as long as being transparent to visible light, and examples thereof include glass sheets; and plastic films (including sheets) such as cycloolefinic polymer films (e.g., “TOPAS” supplied by Daicel Chemical Industries, Ltd.), polyethylene films, polypropylene films, poly(ethylene fluoride) films, poly(vinylidene fluoride) films, poly(vinyl chloride) films, poly(vinylidene chloride) films, poly(methyl methacrylate) films, polycarbonate (PC) films, poly(ether sulfone) films, poly(ether ketone) films, polyamide films, tetrafluoroethylene-perfluoroalkyl vinyl ether copolymer films, polyester films (e.g., poly(ethylene terephthalate) (PET) films), and polyimide films. As used herein the term “(made from) dissimilar materials” refers to that the substrates differ from each other in principle component constituting the substrates (e.g., a component occupying 50 percent by weight or more of the substrate). In the case of copolymers, those including different principle monomer components (e.g., a monomer component occupying 50 percent by weight or more) are “dissimilar materials”. The above listed substrates are dissimilar substrates from one another.

The substrates each have a total light transmittance in the visible light region of preferably 10% or more, more preferably 20% or more, and furthermore preferably 50% or more.

Preferred combinations of the two facing substrates include combinations of a glass sheet and a plastic film, such as a combination of a glass sheet and a polyester film (e.g., a PET film), and a combination of a glass sheet and a polycarbonate film; and combination of a polyester film (e.g., a PET film) and a plastic film selected from the group consisting of polycarbonate films, cycloolefinic polymer films, polyethylene films, polypropylene films, poly(ethylene fluoride) films, poly(vinylidene fluoride) films, poly(vinyl chloride) films, poly(vinylidene chloride) films, poly(methyl methacrylate) films, poly(ether sulfone) films, poly ether ketone films, polyamide films, tetrafluoroethylene-perfluoroalkyl vinyl ether copolymer films, and polyimide films.

The two facing substrates may have an identical refractive index but preferably have different refractive indices. The difference in refractive index (25° C.) between the two substrates is preferably from 0.001 to 0.5. The difference in refractive index, if being excessively large, may cause reflection of light at the interface between one substrate and the photosensitive layer (volume hologram recording layer) or between the photosensitive layer and the other substrates and may thereby often cause a noise.

The substrates have thicknesses each in the range of typically from 2 to 2000 μm and preferably from 10 to 1000 μm. The substrates, if having excessively small thicknesses, may show some problems in surface smoothness as a disk (recording medium) and in warpage of the disk, thus being practically undesirable. Contrarily, the substrates, if having excessively large thicknesses, may cause the medium to have an excessively large total thickness, thus being practically undesirable.

The two facing substrates may have an identical thickness but preferably have different thicknesses. The difference in thickness between the two substrates is typically from 1 to 1500 μm, preferably from 10 to 1000 μm, and more preferably 200 to 1000 μm. The two substrates, when having a large difference in thickness therebetween, may often have a small ratio of second-order diffracted light to first-order diffracted light.

[Manufacturing of Transmission-Type Volume Hologram Recording Medium]

A transmission-type volume hologram recording medium according to the present invention may be manufactured by forming a volume hologram recording layer from a volume hologram recording photosensitive composition between first and second substrates made from dissimilar materials to each other. For example, the transmission-type volume hologram recording medium may be manufactured by applying the volume hologram recording photosensitive composition to the first substrate (one of the two substrates) to form a coat layer; and covering the coat layer with the second substrate (the other substrate) made from a material dissimilar to that of the first substrate to thereby hold the photosensitive composition between the first and second substrates.

The preparation of the volume hologram recording photosensitive composition may employ one or more solvents according to necessity. Exemplary solvents include ketones such as acetone, methyl ethyl ketone, methyl isobutyl ketone, and cyclohexanone; aromatic hydrocarbons such as benzene, toluene, and xylenes; halogenated aromatic hydrocarbons such as chlorobenzene; ethers (cyclic ethers and chain ethers) such as tetrahydrofuran, 1,4-dioxane, and diisopropyl ether; esters such as methyl Cellosolve (ethylene glycol monomethyl ether), ethyl Cellosolve (ethylene glycol monoethyl ether), methyl Cellosolve acetate (ethylene glycol menomethyl ether acetate), ethyl Cellosolve acetate (ethylene glycol monoethyl ether acetate), ethyl acetate, and butyl acetate; halogenated aliphatic hydrocarbons such as 1,2-dichloroethane, dichloromethane, and chloroform; alcohols such as methanol, ethanol, and isopropanol; and mixtures of these solvents. When the volume hologram recording photosensitive composition contains a solvent, the solvent in the coat layer formed on a first substrate is preferably dried and thereby removed before covering of the coat layer with a second substrate made from a dissimilar material to that of the first substrate.

When the volume hologram recording photosensitive composition (coating composition) has a low viscosity, the transmission-type volume hologram recording medium may be manufactured by, after holding the coating composition between the substrates, sealing the periphery of the substrates with a suitable sealing material (e.g., an epoxy or acrylic thermosetting resin, or a photocurable resin) so as to prevent the coating composition from flowing out from the surfaces of the substrates. Where necessary, a spacer film may be arranged between the two substrates so as to surround the coated volume hologram recording photosensitive composition. The thickness of the spacer film may be regulated according to the thickness of the volume hologram recording layer and is typically from about 10 to about 2000 μm.

The application of the coating composition to one substrate (base plate) may be performed according to a known procedure, such as coating with a spin coater, coating with a gravure coater, coating with a comma coater, coating with a bar coater, or coating with an applicator. More simply, a One drop-Filing method may be employed.

The coating composition is coated preferably in such a mass of coating as to allow the resulting volume hologram recording layer to have a thickness of typically from 1 to 2000 μm and preferably from 10 to 1000 μm, as mentioned above.

The coat layer may be aged according to necessity. The aging is performed at a temperature of typically from about 0° C. to about 50° C., and preferably from about 10 to about 40° C. The aging may be performed at room temperature. Though not critical, the aging time is generally from about 0.1 to about 48 hours, preferably from about 0.2 to about 10 hours, and more preferably from about 0.5 to about 5 hours. The aging is preferably performed under light-shielding conditions. The aging process allows the volume hologram recording layer to be smooth and to have stable holographic properties.

The recording of a hologram on the transmission-type volume hologram recording medium according to the present invention may be performed according to a known technique. For example, the recording may be performed by applying recording light (information light) and reference light from the same direction (plane) (transmission recording) according to a two-beam interference technique.

The hologram recording may be performed using visible laser beams such as laser beams from argon ion laser (458 nm, 488 nm, or 514.5 nm), krypton ion laser (647.1 nm), helium-neon ion laser (633 nm), and YAG laser (532 nm) and may be performed by the two-beam interference technique.

For accelerating the refractive index modulation and for completing the polymerization reaction, the recording medium after interference exposure may be subjected to a suitable treatment such as heating or whole image exposure with an ultraviolet ray.

A mechanism for the recording of a hologram using the volume hologram recording photosensitive composition will be described below. Specifically, when a film layer of the photosensitive composition (volume hologram recording layer) is subjected to interference exposure with laser beams, polymerization of the photocurable compound starts in portions exposed to a high-intensity light to cause concentration gradient of the photopolymerizable compound (photocurable compound), and the photopolymerizable compound diffuses and migrates from portions exposed to a low-intensity light to the portions exposed to the high-intensity light. This causes the difference in density of the photopolymerizable compound corresponding to the intensity of interference fringes, resulting in a difference in refractive index. The difference in refractive index enables the recording of a hologram.

The volume hologram recording photosensitive composition may further contain a matrix polymer to reduce the fluidity of monomers. The matrix polymer may be prepared by adding a compound to the photosensitive composition, which compound having a reactivity different from that of other components, and three-dimensionally crosslinking the compound in the manufacture of the recording medium. Typically, when the photosensitive composition is a cationically curable composition, a matrix polymer may be prepared in the recording medium through radical polymerization. Independently, when the photosensitive composition is a radically curable composition, a matrix polymer may be prepared in the recording medium through cationic polymerization. Alternatively, a matrix polymer may be, as the binder polymer, added to and dissolved in the photosensitive composition in advance. When the photosensitive composition contains a binder resin, a hologram is recorded due to the difference in refractive index between the photocurable compound and the binder resin. The refractive index modulation may be accelerated by heating after interference exposure with laser beams, regardless of the presence or absence of binder resins. However, when the photosensitive composition contains a binder resin, the heating after interference exposure is preferably performed at a temperature around the glass transition temperature of the binder resin, because this further accelerates the migration of monomers and further increases the degree of refractive index modulation.

In the resulting transmission-type volume hologram recording medium, the ratio of the intensity of second-order diffracted light to the intensity of first-order diffracted light may be controlled to 10% or less upon hologram reproducing. In addition, the recording medium may have a high diffraction efficiency of typically 40% or more, preferably 50% or more, and particularly preferably 70% or more.

### Examples

The present invention will be illustrated in further detail with reference to several working examples below. It should be noted, however, that these examples are never construed to limit the scope of the present invention. Substrates used in the examples each had a total light transmittance of 50% or more in the visible light region.

(Optical System)

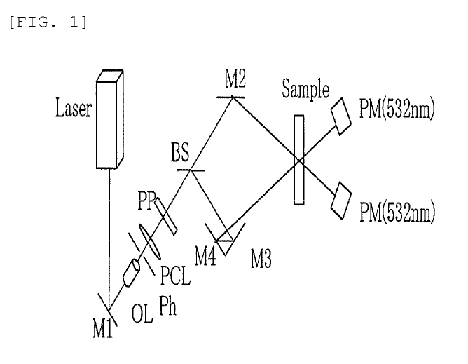

FIG. 1 depicts a schematic diagram of an optical system used in experiments. A light source used herein was 532-nm semiconductor laser, and laser beams emitted therefrom passed through a mirror (M), spatial filters (OL and Ph), a planoconvex lens (PCL), and a retardation plate (PP) and were split into two beams by a beam splitter (BS). The two beams split by the BS were applied via mirrors to the sample at angles of 30 degrees and 30 degrees, respectively, and thereby interfered. The intensities of the diffracted light and transmitted light were respectively determined with power meters (PM: supplied by ADC Corporation).

The diffraction efficiency and the ratio of second-order diffracted light to first-order diffracted light were determined according to the following methods.

(Diffraction Efficiency)

A hologram was recorded by the two-beam interference technique, and the diffraction efficiency thereof was measured with the power meters. Two 532-nm semiconductor laser beams each with a diameter of 5 were applied at angles of each 30 degrees, and the transmitted light and diffracted light were detected. The hologram recording medium was axially rotated at angles of from −5° to 5°, and the diffraction efficiency was calculated at a point where a maximum diffracted light intensity was achieved, according to following Expression (1):

η=L₁/(L₀+L₁) (1)

wherein L₀ represents the intensity of transmitted light; and L₁ represents the intensity of diffracted light.

(Ratio of Second-Order Diffracted Light to First-Order Diffracted Light)

While defining the diffraction efficiencies of first-order diffracted light and second-order diffracted light as η1 and η2, respectively, the ratio of the second-order diffracted light to the first-order diffracted light was calculated according to following Expression (2):

(Ratio of second-order diffracted light to first-order diffracted light)=(η2/η1)×100 (2)

### Example 1

A 7:1 (by mole) liquid mixture of a bifunctional alicyclic epoxy compound (3,4,3′,4′-diepoxybicyclohexyl) and a bifunctional vinyl ether compound (oxynorbornene divinyl ether) was subjected to a heating treatment on an oil bath at 100° C. in an air atmosphere for 30 minutes. A photosensitive composition 1 was prepared by dissolving 100 parts by weight of the cationically polymerizable compounds (as a mixture) after the heating treatment, 60 parts by weight of a poly-2-vinylnaphthalene (weight-average molecular weight Mw=93,000) as a binder polymer, 10 parts by weight of a diphenyliodonium compound (PI2074, supplied by Rhodia) as a photoinitiator, and 0.5 part by weight of a coumarin dye (trade name “NKX1658”, supplied by Hayashibara Biochemical Laboratories, Inc.) as a sensitizing dye in 30 parts by weight of cyclohexanone. The photosensitive composition 1 was applied to a 900-μm thick glass substrate [refractive index: 1.518 (25° C.)] using an applicator so as to give a photosensitive layer 100 μm thick, and a 100-μm thick spacer film (PET) was arranged along the periphery of the substrate so that the spacer film was not in contact with the applied photosensitive composition. The photosensitive layer on the glass substrate was then covered with a 200-μm thick PET film [refractive index: 1.671 (25° C.)] and thereby yielded a hologram recording medium 1. The hologram recording medium 1 was exposed to light from semiconductor laser (532 nm, exposure energy: 100 mJ/cm²) using the two-beam optical system to record a hologram thereon. As a result, the recording medium showed a diffraction efficiency of 55% and a ratio of second-order diffracted light to first-order diffracted light of 8%.

### Example 2

A hologram recording medium 2 was prepared by the procedure of Example 1, except for covering the photosensitive layer with a 200-μm thick polycarbonate (PC) film [refractive index: 1.580 (25° C.)] instead of the 200-μm thick PET film used as the covering substrate. The hologram recording medium 2 was exposed to light from semiconductor laser (532 nm, exposure energy: 100 mJ/cm²) using the two-beam optical system to record a hologram thereon. As a result, the recording medium showed a diffraction efficiency of 61% and a ratio of second-order diffracted light to first-order diffracted light of 6.7%.

### Example 3

The photosensitive composition 1 as in Example 1 was applied to a 200-μm thick PC film [refractive index: 1.580 (25° C.)] as a substrate using an applicator to give a 100-μm thick photosensitive layer, and a 100-μm thick spacer film (PET) was arranged along the periphery of the substrate so that the spacer film was not in contact with the applied photosensitive composition. The photosensitive layer on the PC film was then covered with a 200-μm thick PET film [refractive index: 1.671 (25° C.)] and thereby yielded a hologram recording medium 3. The hologram recording medium 3 was exposed to light from semiconductor laser (532 nm, exposure energy: 100 mJ/cm²) using the two-beam optical system to record a hologram thereon. As a result, the recording medium showed a diffraction efficiency of 40% and a ratio of second-order diffracted light to first-order diffracted light of 5.6%.

### Example 4

The photosensitive composition 1 was applied to a 900-μm thick glass substrate [refractive index: 1.518 (25° C.)] by the procedure of Example 1, and the applied photosensitive composition was left stand with light shielding at room temperature for 24 hours to remove the solvent. A 100-μm thick spacer film (PET) was arranged on the periphery of the substrate so that the spacer film was not in contact with the dried photosensitive composition, and the photosensitive layer on the glass substrate was covered with a 200-μm thick polycarbonate film [refractive index: 1.580 (25° C.)] and thereby yielded a hologram recording medium 4. The hologram recording medium 4 was exposed to light from semiconductor laser (532 nm, exposure energy: 100 mJ/cm²) using the two-beam optical system to record a hologram thereon. As a result, the recording medium showed a diffraction efficiency of 82% and a ratio of second-order diffracted light to first-order diffracted light of 7.1%.

### COMPARATIVE EXAMPLE 1

The photosensitive composition 1 as with Example 1 was applied to a 900-μm thick glass substrate [refractive index: 1.518 (25° C.)] using an applicator give a 100-μm thick photosensitive layer, and a 100-μm thick spacer film (PET) was placed along the periphery of the substrate so that the spacer film was not in contact with the applied photosensitive composition. The resulting photosensitive layer was covered with another ply of the 900-μm thick glass sheet [refractive index: 1.518 (25° C.)] and thereby yielded a hologram recording medium 5. The hologram recording medium 5 was exposed to light from semiconductor laser (532 nm, exposure energy: 100 mJ/cm²) using the two-beam optical system to record a hologram thereon. As a result, the recording medium showed a diffraction efficiency of 14.6% and a ratio of second-order diffracted light to first-order diffracted light of 24.6%.

### COMPARATIVE EXAMPLE 2

The photosensitive composition 1 as with Example 1 was applied to a 1000-μm thick polycarbonate film [refractive index: 1.518 (25° C.)] using an applicator to give 100-μm thick a photosensitive layer. A 100-μm thick spacer film (PET) was arranged along the periphery of the substrate so that the spacer film was not in contact with the applied photosensitive composition. The photosensitive layer was then covered with another ply of the 1000-μm thick polycarbonate film [refractive index: 1.518 (25° C.)] and thereby yielded a hologram recording medium 6. The hologram recording medium 6 was exposed to light from semiconductor laser (532 nm, exposure energy: 100 mJ/cm²) using the two-beam optical system to record a hologram thereon. As a result, the recording medium showed a diffraction efficiency of 22.2% and a ratio of second-order diffracted light to first-order diffracted light of 18.4%.

### COMPARATIVE EXAMPLE 3

The photosensitive composition 1 as with Example 1 was applied to a 200-μm thick PET film [refractive index: 1.671 (25° C.)] using an applicator to give a 100-μm thick photosensitive layer, and a 100-μm thick spacer film (PET) was arranged along the periphery of the substrate so that the spacer film was not in contact with the applied photosensitive composition. The photosensitive layer was then covered with another ply of the 200-μm thick PET film [refractive index: 1.671 (25° C.)] and thereby yielded a hologram recording medium 7. The hologram recording medium 7 was exposed to light from semiconductor laser (532 nm, exposure energy: 100 mJ/cm²) using the two-beam optical system to record a hologram thereon. As a result, the recording medium showed a diffraction efficiency of 26% and a ratio of second-order diffracted light to first-order diffracted light of 16.5%.

### Example 5

A photosensitive composition 2 was prepared by providing and dissolving 70 parts by weight of pentaerythritol triacrylate and 30 parts by weight of neopentyl glycol dimethacrylate both as radically curable compounds, 5 parts by weight of a diphenyliodonium salt compound (PI2074, supplied by Rhodia) as a photoinitiator, 0.15 part by weight of a coumarin dye (NKX1658, supplied by Hayashibara Biochemical Laboratories, Inc.) as a sensitizing dye, and 20 parts by weight of diethyl sebacate as a plasticizer. The photosensitive composition 2 was dropped in a suitable amount onto a 900-μm thick glass substrate [refractive index: 1.518 (25° C.)] to give a photosensitive layer, and a 100-μm thick spacer film (PET) was arranged along the periphery of the substrate so that the spacer film was not in contact with the dropped photosensitive composition. The photosensitive layer on the glass substrate was then covered with a 200-μm thick PET film [refractive index: 1.671 (25° C.)] and thereby yielded a hologram recording medium 8. The hologram recording medium 8 was exposed to light from semiconductor laser (532 nm, exposure energy: 100 mJ/cm²) using the two-beam optical system to record a hologram thereon. As a result, the recording medium showed a diffraction efficiency of 70% and a ratio of second-order diffracted light to first-order diffracted light of 9.1%.

### Example 6

A hologram recording medium 9 was prepared by the procedure of Example 5, except for covering the photosensitive layer on the glass substrate with a 200-μm thick polycarbonate (PC) film [refractive index: 1.580 (25° C.)] instead of the 200-μm thick PET film used as the covering substrate. The hologram recording medium 9 was exposed to light from semiconductor laser (532 nm, exposure energy: 100 mJ/cm²) using the two-beam optical system to record a hologram thereon. As a result, the recording medium showed a diffraction efficiency of 80% and a ratio of second-order diffracted light to first-order diffracted light of 7.7%.

### Example 7

A 7:2:1 (by mole) liquid mixture of a bifunctional alicyclic epoxy compound (3,4,3′,4′-diepoxybicyclohexyl), a monofunctional alicyclic epoxy compound (4-vinylcyclohexene oxide, trade name “CEL 2000”, supplied by Daicel Chemical Industries, Ltd.), and a bifunctional vinyl ether compound (oxynorbornene divinyl ether) was subjected to a heating treatment in an air atmosphere on an oil bath at 100° C. for 30 minutes. A photosensitive composition 3 was prepared by providing and dissolving 100 parts by weight of the mixture of the cationically polymerizable compounds after the heating treatment, 60 parts by weight of a poly-2-vinylnaphthalene (Mw=93,000) as a binder polymer, 10 parts by weight of a diphenyliodonium compound (trade name “PI2074”, supplied by Rhodia) as a photoinitiator, and 0.2 part by weight of a coumarin dye (trade name “NKX1658”, supplied by Hayashibara Biochemical Laboratories, Inc.) as a sensitizing dye. The photosensitive composition was applied to a 900-μm thick glass substrate [refractive index: 1.518 (25° C.)] using an applicator so as to give a photosensitive layer 100 μm thick, and a 100-μm thick spacer film (PET) was arranged along the periphery of the substrate so that the spacer film was not in contact with the applied photosensitive composition. The photosensitive layer was then covered with a 200-μm thick polycarbonate (PC) film [refractive index: 1.580 (25° C.)] and thereby yielded a hologram recording medium 11. The hologram recording medium 11 was exposed to light from semiconductor laser (532 nm, exposure energy: 100 mJ/cm²) using the two-beam optical system to record a hologram thereon. As a result, the recording medium showed a diffraction efficiency of 75% and a ratio of second-order diffracted light to first-order diffracted light of 5.5%.

### COMPARATIVE EXAMPLE 4

The photosensitive composition 2 as with Example 5 was dropped in a suitable amount onto a 900-μm thick glass substrate [refractive index: 1.518 (25° C.)] to form a photosensitive layer, and a 100-μm thick spacer film (PET) was arranged along the periphery of the substrate so that the spacer film was not in contact with the dropped photosensitive composition. The photosensitive layer on the glass substrate was covered with another ply of the 900-μm thick glass sheet [refractive index: 1.518 (25° C.)] and thereby yielded a hologram recording medium 10. The hologram recording medium 10 was exposed to light from semiconductor laser (532 nm, exposure energy: 100 mJ/cm²) using the two-beam optical system to record a hologram thereon. As a result, the recording medium showed a diffraction efficiency of 38% and a ratio of second-order diffracted light to first-order diffracted light of 17.6%.

Next, a hologram recording was performed in an optical system for reflection-type hologram recording as described in Japanese Unexamined Patent Application Publication (JP-A) No. 2007-34334, and the diffraction efficiency thereof was compared with that of a transmission-type hologram. The results are shown below.

### COMPARATIVE EXAMPLE 5

The hologram recording medium 2 prepared in Example 2 was exposed to light at an exposure energy of 100 mJ/cm² from semiconductor laser (532 nm) using the two-beam optical system described in FIG. 1 of Japanese Unexamined Patent Application Publication (JP-A) No. 2007-34334 to carry out reflection-type hologram recording. As a result, the recording medium showed a diffraction efficiency of 26%.

### COMPARATIVE EXAMPLE 6

The hologram recording medium 2 prepared in Example 2 was exposed to light from semiconductor laser (532 nm) by the procedure of Comparative Example 5, except for performing exposure at an exposure energy of 300 mJ/cm², to carry out reflection-type hologram recording. As a result, the recording medium showed a diffraction efficiency of 51%.

### COMPARATIVE EXAMPLE 7

The hologram recording medium 9 prepared in Example 6 was exposed to light at an exposure energy of 100 mJ/cm² from semiconductor laser (532 nm) by the procedure of Comparative Example 5, to carry out reflection-type hologram recording. As a result, the recording medium showed a diffraction efficiency of 41%.

### COMPARATIVE EXAMPLE 8

The hologram recording medium 9 prepared in Example 6 was exposed to light from semiconductor laser (532 nm) by the procedure of Comparative Example 5, except for performing exposure at an exposure energy of 300 mJ/cm², to carry out reflection-type hologram recording. As a result, the recording medium showed a diffraction efficiency of 63%.

### COMPARATIVE EXAMPLE 9

The hologram recording medium 11 prepared in Example 7 was exposed to light from semiconductor laser (532 nm) at an exposure energy of 100 mJ/cm² by the procedure of Comparative Example 5, to carry out reflection-type hologram recording. As a result, the recording medium showed a diffraction efficiency of 33%.

### COMPARATIVE EXAMPLE 10

The hologram recording medium 11 prepared in Example 7 was exposed to light from semiconductor laser (532 nm) by the procedure of Comparative Example 5, except for performing exposure at an exposure energy of 300 mJ/cm², to carry out reflection-type hologram recording. As a result, the recording medium showed a diffraction efficiency of 60%.

As is described above, volume hologram recording media each using dissimilar two substrates, when used in a transmission-type hologram system, can have significantly improved hologram properties such as diffraction efficiency and separability between first-order diffracted light and second-order diffracted light, as compared to recording media each using two substrates of an identical material. These advantageous effects are available both in cationically curable systems and radically curable systems.

### INDUSTRIAL APPLICABILITY

The transmission-type volume hologram recording media according to the present invention each have a high diffraction efficiency, are capable of reducing the intensity of diffracted light which causes a noise, and excel in separability between first-order diffracted light and second-order diffracted light, as compared to conventional equivalents. The recording media are therefore advantageously usable as hologram memory recording materials which serve as large-capacity recording media.

1. A transmission-type volume hologram recording medium comprising two facing substrates composed of dissimilar materials to each other; and a volume hologram recording layer held between the two substrates and composed of a volume hologram recording photosensitive composition.

2. The transmission-type volume hologram recording medium according to claim 1, wherein the two substrates holding the volume hologram recording layer therebetween are each transparent to light in the visible light region and have thicknesses each in the range of from 2 to 2000 μm.

3. The transmission-type volume hologram recording medium according to claim 1, wherein the recording medium has a difference in refractive index of from 0.001 to 0.5 between the two substrates holding the volume hologram recording layer therebetween.

4. The transmission-type volume hologram recording medium according to claim 1, wherein the recording medium has a difference in thickness of from 1 to 1500 μm between the two substrates holding the volume hologram recording layer therebetween.

5. The transmission-type volume hologram recording medium according to claim 1, wherein, upon reproduction of a hologram recorded on the recording medium, the intensity of second-order diffracted light is 10% or less with respect to the intensity of first-order diffracted light.

6. A method for manufacturing a transmission-type volume hologram recording medium, the method comprising the step of forming a volume hologram recording layer between first and second substrates, the volume hologram recording layer including a volume hologram recording photosensitive composition, and the first and second substrates made from dissimilar materials to each other.

7. The method for manufacturing a transmission-type volume hologram recording medium, according to claim 6, wherein the method comprises the steps of applying the volume hologram recording photosensitive composition to the first substrate to form a coat layer thereon; and covering the coat layer with the second substrate made from a dissimilar material to that of the first substrate.

8. The method for manufacturing a transmission-type volume hologram recording medium, according to claim 7, wherein the method comprises the steps of drying and removing a solvent from the coat layer formed on the first substrate; and covering the dried coat layer with the second substrate made from a dissimilar material to that of the first substrate.

9. The transmission-type volume hologram recording medium according to claim 2, wherein the recording medium has a difference in refractive index of from 0.001 to 0.5 between the two substrates holding the volume hologram recording layer therebetween.

10. The transmission-type volume hologram recording medium according to claim 2, wherein the recording medium has a difference in thickness of from 1 to 1500 μm between the two substrates holding the volume hologram recording layer therebetween.

11. The transmission-type volume hologram recording medium according to claim 3, wherein the recording medium has a difference in thickness of from 1 to 1500 μm between the two substrates holding the volume hologram recording layer therebetween.

12. The transmission-type volume hologram recording medium according to claim 2, wherein, upon reproduction of a hologram recorded on the recording medium, the intensity of second-order diffracted light is 10% or less with respect to the intensity of first-order diffracted light.

13. The transmission-type volume hologram recording medium according to claim 3, wherein, upon reproduction of a hologram recorded on the recording medium, the intensity of second-order diffracted light is 10% or less with respect to the intensity of first-order diffracted light.

14. The transmission-type volume hologram recording medium according to claim 4, wherein, upon reproduction of a hologram recorded on the recording medium, the intensity of second-order diffracted light is 10% or less with respect to the intensity of first-order diffracted light.
